(19) United States
(12) Patent Application Publication
(10) Pub. No.: US 2013/0201191 A1
(43) Pub. Date: Aug. 8, 2013

(54) MULTIDIMENSIONAL DATA VISUALIZATION APPARATUS, METHOD, AND PROGRAM

(71) Applicants: Satoshi MORINAGA, Minato-ku (JP); Ryohei FUJIMAKI, Minato-ku (JP); Takayuki ITOH, Bunkyo-ku (JP); Yunzhu ZHENG, Bunkyo-ku (JP); Haruka SUEMATSU, Bunkyo-ku (JP)

(72) Inventors: Satoshi MORINAGA, Minato-ku (JP); Ryohei FUJIMAKI, Minato-ku (JP); Takayuki ITOH, Bunkyo-ku (JP); Yunzhu ZHENG, Bunkyo-ku (JP); Haruka SUEMATSU, Bunkyo-ku (JP)

(73) Assignee: NEC CORPORATION, Tokyo (JP)

(21) Appl. No.: 13/484,502

(22) Filed: May 31, 2012

Related U.S. Application Data
(60) Provisional application No. 61/594,831, filed on Feb. 3, 2012.

(51) Int. Cl. G06T 11/20

(52) U.S. Cl. 345/440

(57) ABSTRACT

There is provided a multidimensional data visualization apparatus capable of visualizing the distribution of data in an input space of high-dimensional data so that the relationships between input dimensions can be seen. Subplot generation means 71 generates, from input multidimensional data, multiple subplots as charts representing data on some dimensions in the multidimensional data. Feature value calculation means 72 calculates the feature value of a relationship between paired subplots for each pair of subplots. Coordinate calculation means 73 calculates the coordinates, at which each subplot is placed, based on the feature value calculated by the feature value calculation means 72.

### BACKGROUND OF THE INVENTION

1. Field of the Invention

The present invention relates to a multidimensional data visualization apparatus, a multidimensional data visualization method, and a multidimensional data visualization program for visualizing multidimensional data to make it easy for persons to grasp the data.

2. Description of the Related Art

With the recent rapid development of data infrastructure, efficient processing of large-volume and massive data has become one of the important issues for the industry. In data analysis, it is crucial for an analyst to understand the distribution and statistical characteristics of data, and hence emphasis is on the technique for visualizing data. Then, when the dimension of data is more than the three dimension, since the data cannot be visualized directly using scatter plots or the like, the implementation of a method of visualizing high-dimensional data is one of big issues for visualization technology.

As a multidimensional data visualization technique, there is Scatter Plot Matrix (hereinafter, referred to as SP Matrix). In an SP Matrix, a screen is divided into a grid-like pattern, and multiple two-dimensional scatter plots (note that the scatter plot may be abbreviated as SP below) obtained from multidimensional data are placed in divided regions. An example of multidimensional data visualization using Scatter Plot Matrix is illustrated in FIG. 8. FIG. 8 shows an example in which 13-dimensional data are visualized by Scatter Plot Matrix.

As another example of the multidimensional data visualization technique, there is PCP (Parallel Coordinates Plot) (see Non Patent Literature (NPTL) 1). The PCP is a graph for placing axes for each individual dimension in parallel and connecting values on respective axes with line segments to visualize multidimensional data. FIG. 9 shows an example of the PCP representing 13-dimensional data in FIG. 8.

Further, as still another example of the multidimensional data visualization technique, there is a dimension compression technique. A low-dimension compression technique is a method of calculating, from data, projection or embedding into a low-dimensional space well-representing the characteristics of high-dimensional data to visualize data in the low-dimensional space using SPs or the like. As an example of the dimension compression technique, there is Isomap (see NPTL 2) or the like.

In addition, technology concerned with a layout of multiple graphs is disclosed in NPTL 3 and NPTL 4.

### CITATION LIST

### Non Patent Literatures

NPTL 1: Alfred Inselberg and Bernard Dimsdale, “Parallel Coordinates: A Tool for Visualizing Multi-dimensional Geometry,” IEEE Visualization '90.

NPTL 2: J. B. Tenenbaum, V. de Silva, and C. Langford, “A Global Geometric Framework for Nonlinear Dimensionality Reduction,” Science Vol. 290 (5500), pp. 2319-2323, 22 Dec. 2000.

NPTL 3: T. Itoh, C. Muelder, K.-L. Ma, and J. Sese, “A Hybrid Space-Filling and Force-Directed Layout Method for Visualizing Multiple-Category Graphs,” IEEE Pacific Visualization Symposium, pp. 121-128, 2009.

NPTL 4: Takayuki Itoh, Yumi Yamaguchi, and Koji Koyamada, “An Improvement of Nested-Rectangle-Based Hierarchical Data Visualization Technique,” Transaction of the Visualization Society of Japan, Vol. 26 (2006), No. 6, pp. 51-61.

### SUMMARY OF THE INVENTION

In the SP Matrix, since the multiple two-dimensional scatter plots obtained from the multidimensional data are placed in the grid-like pattern, the size of each grid becomes small as the dimensions of data increase (for example, when they exceed several dozen dimensions), resulting in degradation of visibility.

Therefore, it is considered a combination of the SP Matrix and dimension selection. For example, when input data are in a hundred dimensions, only ten dimensions among the dimensions are selected and displayed in the SP Matrix. However, there is a problem of little information in most pairs of the selected dimensions or a problem of making it hard to understand a relationship between two-dimensional scatter plots (i.e., a relationship between input dimensions). The following shows an example of such problems. FIG. 10 is an illustration showing a highlighted display of the top five subplots with low class level entropy regarding the same data as shown in FIG. 8 (i.e., the top five subplots in which data in each class can be well separated). It is apparent from FIG. 10 that subplots having similar information are not always located close to each other in the SP Matrix. This makes it extremely difficult to understand a relationship between respective input dimensions (i.e., respective dimensions in the input multidimensional data).

Note that the subplot means a chart representing data on some dimensions in the multidimensional data.

Further, the PCP (see FIG. 9) has the following problems: First, it is hard to understand the relation between axes that are not adjacent to each other in the PCP. It also becomes hard to grasp the entire aspect in the PCP as the number of dimensions increases. Further, in the PCP, it is hard to visually grasp information such as on class separability. Referring for example to FIG. 10, it is found that there are subplots in which respective classes are well separated, but it is hard to grasp the goodness of separation of data in the PCP illustrated in FIG. 9.

Further, the dimension compression technique has the following problem: Since each dimension in a projected low-dimensional space is expressed as a linear function or a nonlinear function of input dimensions, the overall tendency of data can be figured out, but it is difficult to understand the relationship between input dimensions.

Therefore, it is an object of the present invention to provide a multidimensional data visualization apparatus, a multidimensional data visualization method, and a multidimensional data visualization program, capable of visualizing the distribution of data in an input space of high-dimensional data so that the relationships between input dimensions can be seen.

### Solution to Problems

A multidimensional data visualization apparatus according to the present invention includes: subplot generation means for generating, from input multidimensional data, multiple subplots as charts representing data on some dimensions in the multidimensional data; feature value calculation means for calculating the feature value of a relationship between paired subplots for each pair of subplots; and coordinate calculation means for calculating the coordinates, at which each subplot is placed, based on the feature value calculated by the feature value calculation means.

A multidimensional data visualization method according to the present invention includes: generating, from input multidimensional data, multiple subplots as charts representing data on some dimensions in the multidimensional data; calculating the feature value of a relationship between paired subplots for each pair of subplots; and calculating the coordinates, at which each subplot is placed, based on the feature value.

A multidimensional data visualization program according to the present invention causes a computer to perform: subplot generation processing for generating, from input multidimensional data, multiple subplots as charts representing data on some dimensions in the multidimensional data; feature value calculation processing for calculating the feature value of a relationship between paired subplots for each pair of subplots; and coordinate calculation processing for calculating the coordinates, at which each subplot is placed, based on the feature value calculated in the feature value calculation processing.

According to the present invention, the distribution of data in an input space of high-dimensional data can be so visualized that the relationships between input dimensions can be seen.

### BRIEF DESCRIPTION OF THE DRAWINGS

FIG. 1 is a schematic diagram schematically showing an example of a screen output according to the present invention.

FIG. 2 is a block diagram showing an example of a multidimensional data visualization apparatus according to a first exemplary embodiment of the present invention.

FIG. 3 contains graphs showing an example of correlation analysis according to class label.

FIG. 4 is a flowchart showing an example of the progress of processing in the first exemplary embodiment.

FIG. 5 is a block diagram showing a multidimensional data visualization apparatus according to a second exemplary embodiment of the present invention.

FIG. 6 is a flowchart showing an example of the progress of processing in the second exemplary embodiment.

FIG. 7 is a block diagram showing an example of the minimum configuration of a multidimensional data visualization apparatus according to the present invention.

FIG. 8 is an illustration showing an example of visualization of multidimensional data by Scatter Plot Matrix.

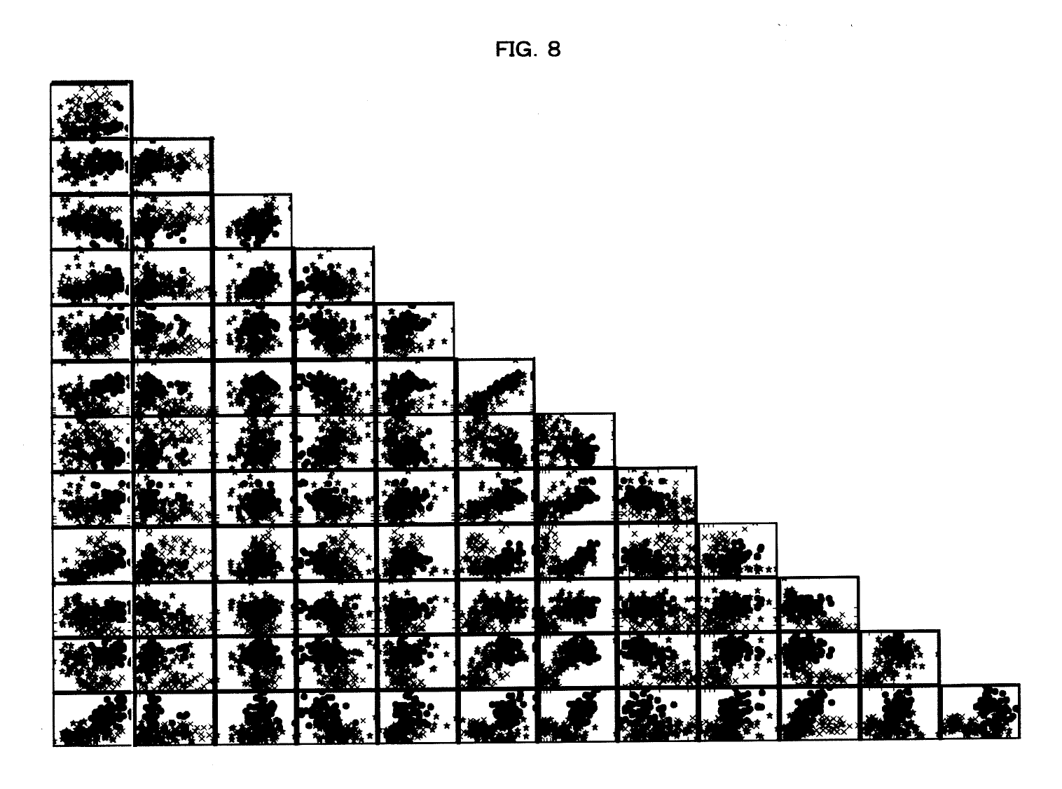

FIG. 9 is an illustration showing an example of the PCP.

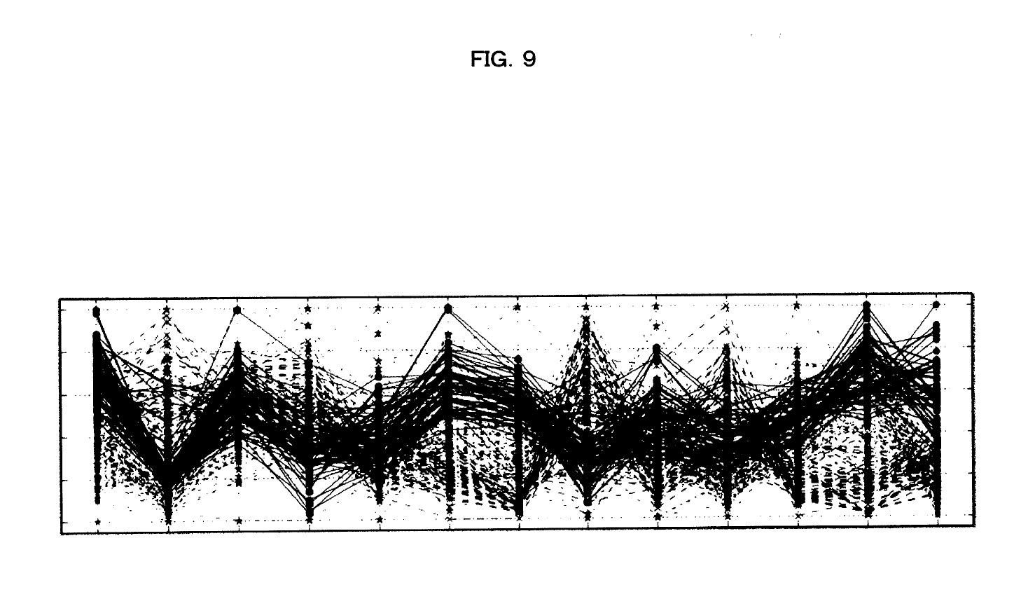

FIG. 10 is an illustration showing a highlighted display of the top five subplots with low class level entropy regarding the same data as shown in FIG. 8.

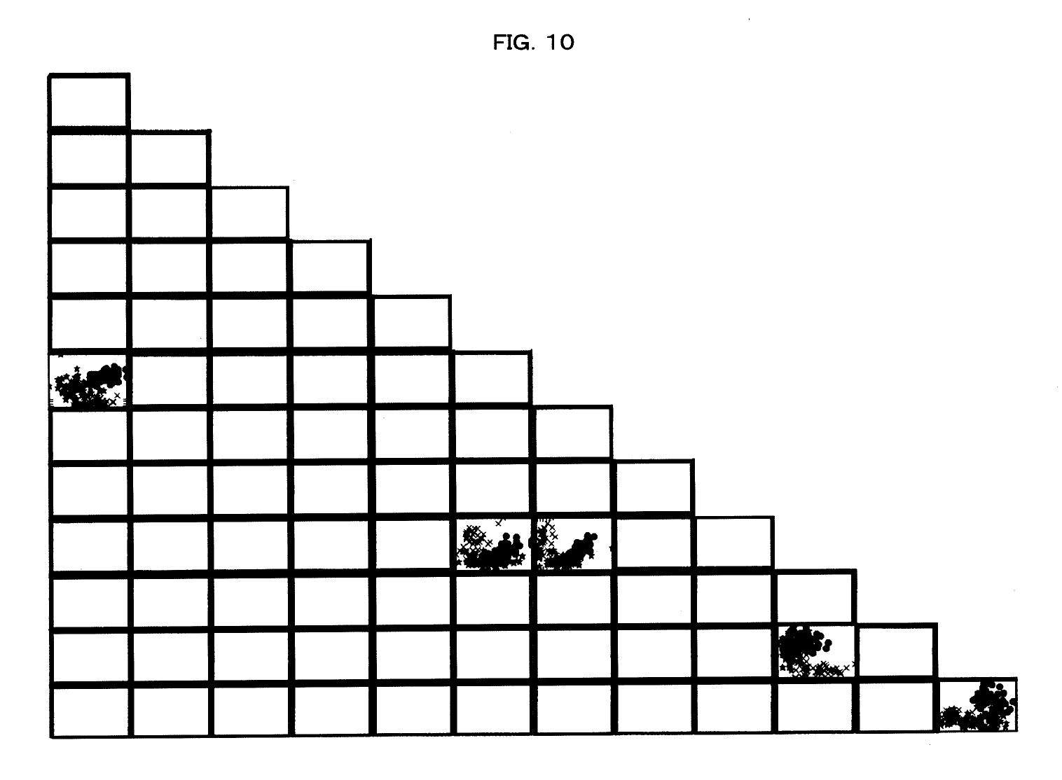

### DESCRIPTION OF THE PREFERRED EMBODIMENTS

Exemplary embodiments of the present invention will now be described with reference to the accompanying drawings.

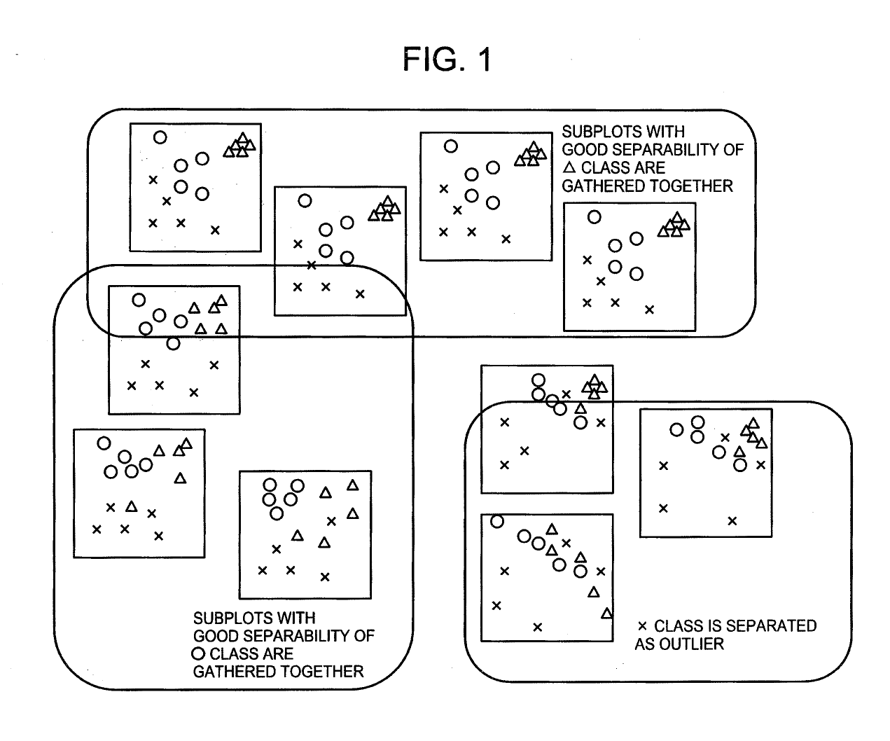

A multidimensional data visualization apparatus according to the present invention visualizes multidimensional data by placing multiple subplots generated from the multidimensional data on a screen, for example, as illustrated in FIG. 1. As already mentioned, the subplot means a chart representing data on some dimensions in the multidimensional data. The subplot can also be referred to as the low-dimensional visualization results of multidimensional data. In FIG. 1, an example of using two-dimensional scatter plots as subplots is shown, but the mode of subplots is not limited thereto. For example, the multidimensional data visualization apparatus according to the present invention may generate multiple subplots using some axes in the PCP representing the multidimensional data and place the multiple subplots on the screen.

Further, upon placing multiple subplots on the screen, the multidimensional data visualization apparatus according to the present invention places subplots having similar features close to each other. As a result, the layout of subplots can represent the relationships between input dimensions (respective dimensions in the input multidimensional data).

### Exemplary Embodiment 1

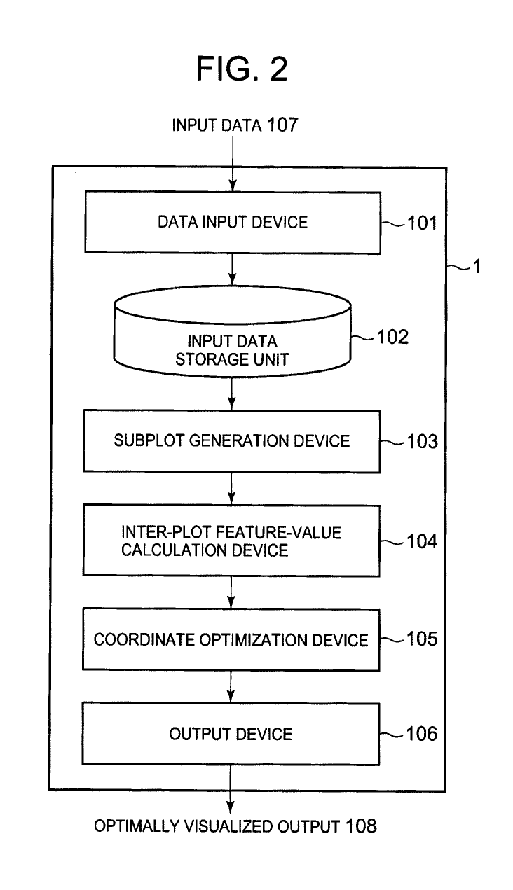

FIG. 2 is a block diagram showing an example of a multidimensional data visualization apparatus according to a first exemplary embodiment of the present invention. A multidimensional data visualization apparatus 1 according to the first exemplary embodiment of the present invention includes a data input device 101, an input data storage unit 102, a subplot generation device 103, an inter-plot feature-value calculation device 104, a coordinate optimization device 105, and an output device 106.

Input data 107 is input into the multidimensional data visualization apparatus 1, and optimally visualized output 108 is output. The input data 107 is multidimensional data, and the optimally visualized output 108 is the results of placement of multiple subplots generated based on the multidimensional data.

The data input device 101 is an interface device for inputting the input data 107. As mentioned above, the input data 107 is multidimensional data. The following description will be made assuming that the multidimensional data input as the input data 107 is D-dimensional multidimensional data. It is also assumed that the number of multidimensional data input as the input data 107 is N.

Examples of the multidimensional data include the following data: For example, D-dimensional data having N points can be obtained from N cars having D sensors. Further, for example, D-dimensional data having N points can be obtained from N patients having D kinds of health checkup information. Thus, N D-dimensional data can be used as the input data 107. Note that the two kinds of D-dimensional data mentioned here are illustrative examples, and the input data 107 is not limited to the above-mentioned examples.

Upon inputting the input data 107, a parameter necessary for analysis may be input together into the data input device 101. As an example of the parameter necessary for analysis, there is a parameter or the like for specifying a feature value (feature value representing a relationship between subplots) to be described later. Further, for example, when the coordinate optimization device 105 uses principal component analysis or Isomap, there is an input parameter or the like for principal component analysis or Isomap. Note that the kind of parameter input together with the input data 107 is not particularly limited.

The input data storage unit 102 is a storage unit for storing the input data 107 input into the data input device 101.

The subplot generation device 103 uses a predetermined method to generate subplots (low-dimensional visualization results) based on the D-dimensional data (the input data 107). For example, the subplot generation device 103 may generate, as subplots, two-dimensional scatter plots for combinations in each input dimension. The two-dimensional scatter plot is an example of the subplot, and the subplot generation device 103 may generate another mode of subplots. For example, the subplot generation device 103 may set, as subplots, the PCP having axes corresponding to some dimensions in the D-dimensional data to generate such multiple subplots.

An example of the method by which the subplot generation device 103 generates subplots will be described. For example, the subplot generation device 103 may generate all subplots capable of being generated from the input multidimensional data.

Further, for example, the subplot generation device 103 may calculate statistics in low-dimensional spaces as candidates and rank the candidates using the statistics to generate the specified number of subplots in order from the top. In more specific example, for example, the subplot generation device 103 calculates certain statistics in certain two-dimensional spaces (e.g., entropy related to class separability) to rank the subplot candidates (e.g., ways of selecting two axes in the two-dimensional scatter plots) based on the statistics. In this example, the subplot candidates have just to be ranked in ascending order of entropy. Then, the subplot generation device 103 has just to generate the specified number of subplots from the top.

Note that the above subplot generation method is an illustrative example, and the method by which the subplot generation device 103 generates subplots is not limited to the above example.

The inter-plot feature-value calculation device 104 uses a predetermined method to calculate a feature value representing a relationship between respective subplots generated by the subplot generation device 103. In other words, the inter-plot feature-value calculation device 104 calculates the feature value of a relationship between paired subplots for each pair of subplots. The feature value is determined depending on from what standpoint the subplots are placed and visualized on a screen.

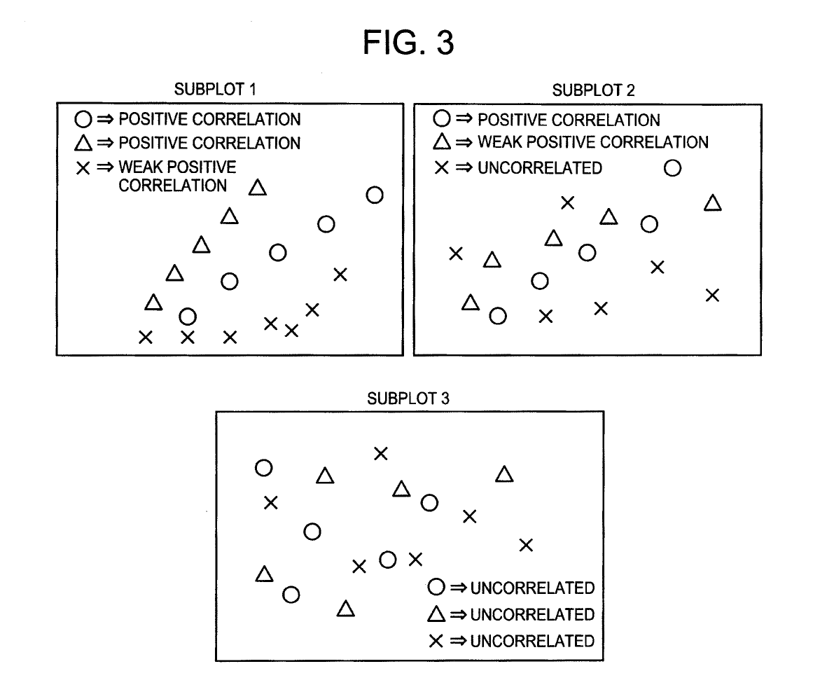

An example of the feature value of a relationship between subplots will be described. FIG. 3 contains graphs showing an example of correlation analysis according to class label. In FIG. 3, the class labels of data are distinguished by markers in each subplot. Subplot 1 and subplot 2 shown in FIG. 3 are similar in tendency from the standpoint of correlation analysis according to class label. Therefore, the subplot 1 and the subplot 2 can be placed close to each other on the screen to visualize in what subspace a correlation appears. On the other hand, subplot 3 is different in tendency of correlation from the subplot 1 and the subplot 2. Therefore, it is preferred to locate the subplot 3 away from the subplot 1 and the subplot 2 in the screen. Thus, in this example, an index value representing the tendency of correlation between subplots has just to be used as the feature value of the relationship between subplots. As in this example, when subplots similar in tendency of correlation are placed close to each other and subplots different in tendency of correlation are placed far away from each other, the inter-plot feature-value calculation device 104 calculates, for example, a correlation coefficient for each subplot on a per class-label basis to calculate a vector (hereinafter referred to as “correlation coefficient vector”) obtained by vectorizing the class label-specific correlation coefficient. In the example shown FIG. 3, a correlation coefficient has just to be calculated for each subplot per kind of marker. In FIG. 3, since three kinds of markers are illustrated, three kinds of correlation coefficients can be obtained for each individual subplot. Further, in this example, three-dimensional vectors having the three kinds of correlation coefficients as elements become the correlation coefficient vectors.

Then, the inter-plot feature-value calculation device 104 has just to calculate a distance between correlation coefficient vectors for each pair of subplots. The distance between correlation coefficient vectors thus calculated can be used as a feature value representing a relationship between subplots.

Note that the above-mentioned distance between correlation coefficient vectors is just an example of the feature value representing a relationship between subplots, and any value other than the distance between correlation coefficient vectors may be calculated as the feature value.

Further, depending on the parameter input into the data input device 101, the inter-plot feature-value calculation device 104 may change the kind of feature value to be calculated.

Based on the feature value representing a relationship between subplots calculated by the inter-plot feature-value calculation device 104, the coordinate optimization device 105 optimizes the layout of each subplot in a low-dimensional coordinate space. For example, it decides on the optimum coordinates for the layout of each subplot in a two-dimensional space.

As a method of optimizing the layout of each subplot, a dimension compression technique typified by principal component analysis or Isomap (see NPTL 2) can be employed. The following will describe an example of optimization of the layout of each subplot by taking Isomap for example. In this case, as in the example mentioned above, the inter-plot feature-value calculation device 104 has just to calculate, for each pair of subplots, the distance between correlation coefficient vectors as the feature value representing a relationship between subplots. Then, the coordinate optimization device 105 may define a distance matrix from distances between correlation coefficient vectors and set the distance matrix as input into Isomap to calculate the coordinates at which the distance relationships between correlation vectors are best conserved in the low-dimensional coordinate space.

An example of coordinate calculation processing performed by the coordinate optimization device 105 will be shown more specifically. In this example, it is assumed that the number of subplots is ten and respective subplots are denoted as P1 to P10. It is also assumed that the class labels are of seven kinds. Further, a case where the inter-plot feature-value calculation device 104 calculates, as mentioned above, the distance between correlation coefficient vectors as the feature value representing a relationship between subplots is taken for example. In this case, since the class labels are of seven kinds, correlation coefficient vectors V1 to V10 of respective subplots are seven-dimensional vectors, respectively. Note that Vn is a correlation coefficient vector of subplot Pn. Here, n used as the suffix is an integer from 1 to 10.

When the number of subplots is k, the distance matrix is a k×k matrix. Therefore, the distance matrix in this example is a 10×10 matrix. The coordinate optimization device 105 sets the distance between correlation coefficient vector Vi and correlation coefficient vector Vj (i.e., feature value between subplots Pi and Pj) as the ij element in the distance matrix to define each element of the distance matrix in order to define the distance matrix. The coordinate optimization device 105 has just to input this distance matrix into Isomap to calculate coordinates in a low-dimensional space corresponding to each of subplots P1 to P10.

Note that the method of calculating the coordinates corresponding to each subplot is not limited to the above example. For example, as mentioned above, principal component analysis may be employed to calculate the coordinates corresponding to each subplot.

The output device 106 outputs the calculated subplots and the layout as optimally visualized output 108. For example, the output device 106 has just to output an image in which each subplot is placed at the optimum coordinates. The output device 106 has just to display such an image, for example, on a display device, but the output mode of the output device 106 is not particularly limited. For example, the output device 106 may print out the image.

The data input device 101, the input data storage unit 102, the subplot generation device 103, the inter-plot feature-value calculation device 104, the coordinate optimization device 105, and the output device 106 may also be independent devices, respectively. Alternatively, each of these devices may be implemented by a computer including an interface device as the data input device 101 and a storage unit as the input data storage unit 102. In this case, the computer has just to read a multidimensional data visualization program to provide the operation of each device according to the program.

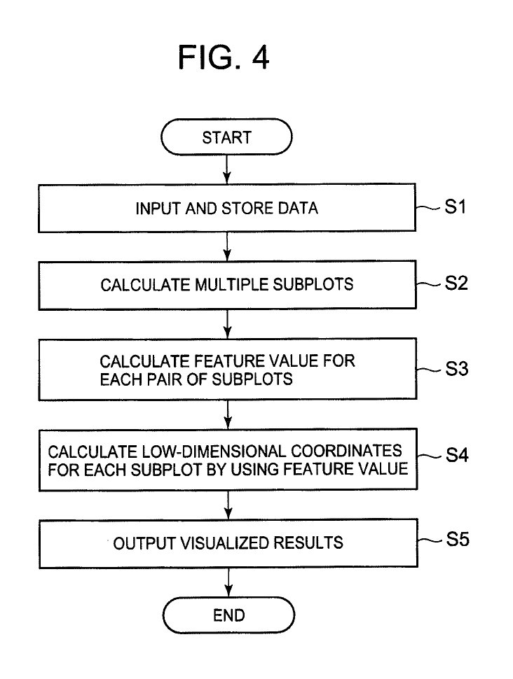

Next, the progress of processing in the first exemplary embodiment will be described. FIG. 4 is a flowchart showing the progress of processing in the first exemplary embodiment. When input data 107 is input into the data input device 101, the input data storage unit 102 stores the input data 107 (step S1).

Next, the subplot generation device 103 calculates multiple subplots based on the input data 107 (step S2).

Next, the inter-plot feature-value calculation device 104 calculates the feature value of a relationship between paired subplots for each pair of subplots (step S3).

Next, the coordinate optimization device 105 uses the feature value of the relationship between subplots calculated in step S3 to calculate low-dimensional coordinates for each subplot (step S4).

Then, the output device 106 outputs optimally visualized output 108 (step S5). The output device 106 outputs an image in which each subplot is placed at the optimum low-dimensional coordinates.

According to the present invention, the inter-plot feature-value calculation device 104 calculates the feature value for providing an indication of the layout of subplots from a desired standpoint. Then, the coordinate optimization device 105 uses the feature value to calculate the coordinates at which each subplot in a low-dimensional space is placed. Thus, the distribution of data can be so visualized that a relationship between input dimensions in the input multidimensional data can be seen.

For example, closely related subplots, such as those similar in tendency of correlation or the like, can be displayed at a close distance and unrelated subplots can be displayed away from each other. Further, the kind of feature value can be changed to adjust from what standpoint high-dimensional data will be visualized.

In addition, in the SP Matrix, there are many cases of little information in most pairs of the selected dimensions. In such cases, relationships between two-dimensional scatter plots with little information are displayed to occupy screen areas, but the present invention can avoid this situation.

### Exemplary Embodiment 2

In the first exemplary embodiment, the coordinate optimization device 105 uses the feature value representing a relationship between subplots to calculate coordinates in a low-dimensional space at which each subplot is placed. Then, each plot is displayed at the coordinates. In this case, even if the coordinates of the subplot are the optimum coordinates based on a desired ground, the display may be hard to see for a person who looks at the display. For example, in the first exemplary embodiment, there can arise situations in which subplots are overlapped in the display, subplots are displayed in an unaligned state, sparse and dense subplots or wasted spaces appear on the screen, and the like. A multidimensional data visualization apparatus of a second exemplary embodiment refers to the low-dimensional coordinates calculated by the coordinate optimization device 105 to optimize the layout of subplots to improve visualization of each subplot.

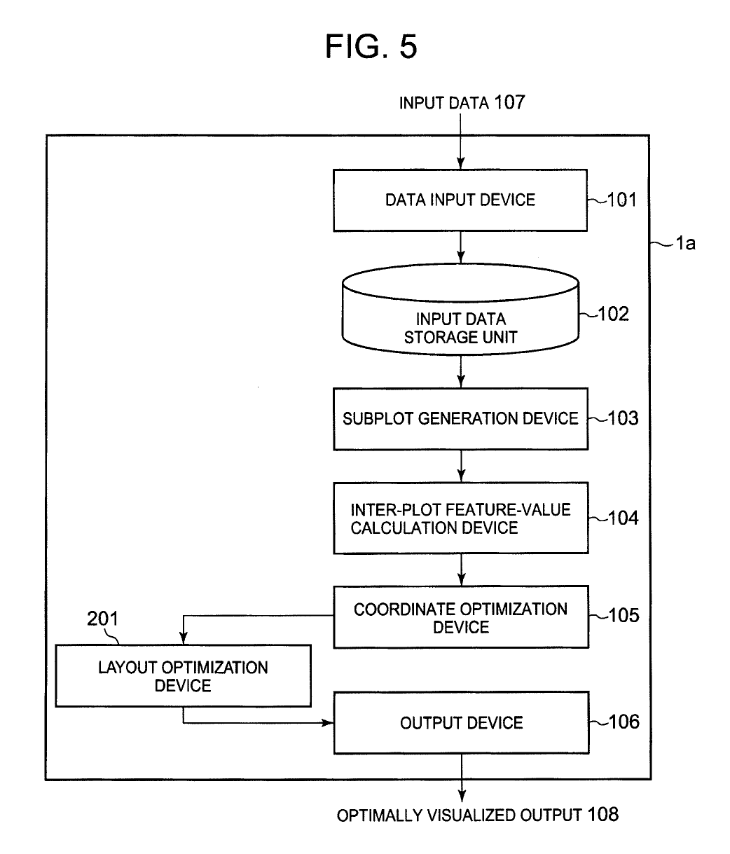

FIG. 5 is a block diagram showing an example of a multidimensional data visualization apparatus according to the second exemplary embodiment of the present invention. The same components as those in the first exemplary embodiment are given the same reference numerals as in FIG. 2 to omit the redundant description. In addition to the data input device 101, the input data storage unit 102, the subplot generation device 103, the inter-plot feature-value calculation device 104, the coordinate optimization device 105, and the output device 106, a multidimensional data visualization apparatus la according to the second exemplary embodiment of the present invention further includes a layout optimization device 201.

The layout optimization device 201 uses the coordinates of each subplot calculated by the coordinate optimization device 105 as reference coordinates to optimize the layout position of the subplot. The optimization method practiced by the layout optimization device 201 may be any method. For example, any of the methods described in NPTLs 3 and 4 can be used.

An example of optimization processing performed by the layout optimization device 201 on the layout position of each subplot will be shown. The layout optimization device 201 generates a network structure for connecting subplots placed at the coordinates calculated by the coordinate optimization device 105. As an example of a method of generating this network structure, for example, there is a method of linking a predetermined number of highly-correlated pairs among any pairs of subplots. Whether the correlation between paired subplots is high may be determined by comparing the feature value between subplots calculated by the inter-plot feature-value calculation device 104 with a threshold. Then, the layout optimization device 201 assumes the application of the same dynamics as springs to the generated links to decide on an assumed position of each subplot in a low-dimensional space by doing repeated calculations of a motion equation. Further, the layout optimization device 201 refers to this assumed position and applies a rectangular space filling technique to decide on a final position of each subplot in the low-dimensional space.

The layout optimization device 201 may be a device independent of the other devices. Alternatively, each of the devices including the layout optimization device 201 may be implemented by a computer including an interface device as the data input device 101 and a storage unit as the input data storage unit 102.

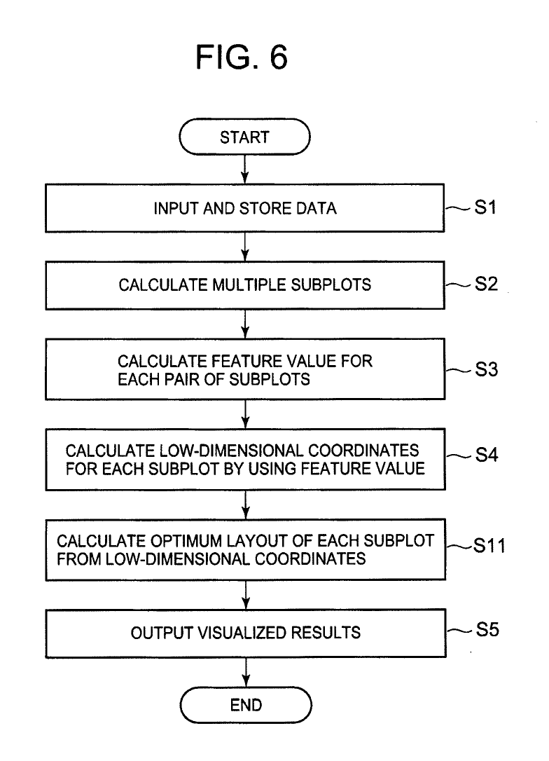

FIG. 6 is a flowchart showing an example of the progress of processing in the second exemplary embodiment. The same operations as those in the first exemplary embodiment are given the same reference numerals as those in FIG. 4. The operations from step S1 to step S4 are the same as those in the first exemplary embodiment.

In the second exemplary embodiment, after step S4, the layout optimization device 201 uses the coordinates of each subplot calculated in step S4 as reference coordinates to optimize the layout position of the subplot (step S11).

Then, the output device 106 outputs optimally visualized output 108 (step S5). The output device 106 has just to output an image in which each subplot is placed at the coordinates optimized in step S11.

According to the second exemplary embodiment, the same effects as in the first exemplary embodiment can be obtained. In addition, since the layout optimization device 201 optimizes the layout position of each subplot, the visibility of each subplot can be improved.

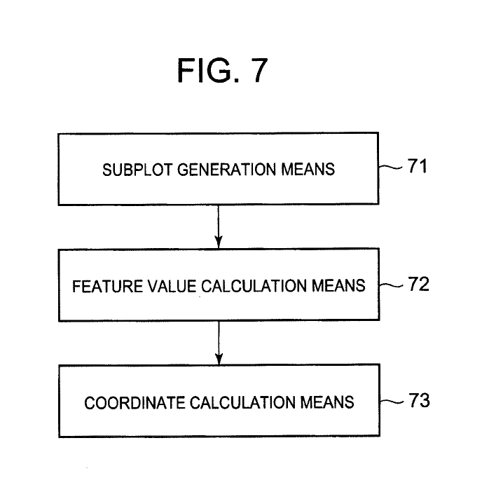

The following will describe the minimum configuration of the present invention. FIG. 7 is a block diagram showing an example of the minimum configuration of a multidimensional data visualization apparatus according to the present invention. The multidimensional data visualization apparatus includes subplot generation means 71, feature value calculation means 72, and coordinate calculation means 73.

The subplot generation means 71 (e.g., the subplot generation device 103) generates, from input multidimensional data, multiple subplots as charts representing data on some dimensions in the multidimensional data.

The feature value calculation means 72 (e.g., the inter-plot feature-value calculation device 104) calculates the feature value of a relationship between paired subplots for each pair of subplots.

The coordinate calculation means 73 (e.g., the coordinate optimization device 105) calculates the coordinates, at which each subplot is placed, based on the feature value calculated by the feature value calculation means 72.

According to such a configuration, the distribution of data in an input space of high-dimensional data can be so visualized that the relationships between input dimensions can be seen.

The configuration may further include layout optimization means (e.g., the layout optimization device 201) for optimizing the layout position of each subplot based on the coordinates calculated by the coordinate calculation means 73.

Part or all of the aforementioned exemplary embodiments can be described as, but not limited to, the following supplementary notes:
(Supplementary Note 1) A multidimensional data visualization apparatus including: a subplot generation unit for generating, from input multidimensional data, multiple subplots as charts representing data on some dimensions in the multidimensional data; a feature value calculation unit for calculating the feature value of a relationship between paired subplots for each pair of subplots; and a coordinate calculation unit for calculating the coordinates, at which each subplot is placed, based on the feature value calculated by the feature value calculation unit.
(Supplementary Note 2) The multidimensional data visualization apparatus according to Supplementary Note 1, further including a layout optimization unit for optimizing the layout position of each subplot based on the coordinates calculated by the coordinate calculation unit.

As described above, although the present invention is described with reference to the exemplary embodiments, the present invention is not limited to the aforementioned exemplary embodiments. Various changes that can be understood by those skilled in the art within the scope of the present invention can be made to the configurations and details of the present invention.

The present invention can be suitably applied to a multidimensional data visualization apparatus for visualizing multidimensional data to make it easy for persons to grasp the data.

### Reference Signs List

1, 1a Multidimensional Data Visualization Apparatus

101 Data Input Device

102 Input Data Storage Unit

103 Subplot Generation Device

104 Inter-Plot Feature-Value Calculation Device

105 Coordinate Optimization Device

106 Output Device

201 Layout Optimization Device

1-6. (canceled)

7. A multidimensional data visualization apparatus comprising:
a subplot generation unit for generating, from input multidimensional data, a plurality of subplots as charts representing data on some dimensions in the multidimensional data;
a feature value calculation unit for calculating a feature value of a relationship between paired subplots for each pair of subplots; and
a coordinate calculation unit for calculating coordinates, at which each subplot is placed, based on the feature value calculated by the feature value calculation unit.

8. The multidimensional data visualization apparatus according to claim 7, further comprising a layout optimization unit for optimizing a layout position of each subplot based on the coordinates calculated by the coordinate calculation unit.

9. A multidimensional data visualization method comprising:
generating, from input multidimensional data, a plurality of subplots as charts representing data on some dimensions in the multidimensional data;
calculating a feature value of a relationship between paired subplots for each pair of subplots; and
calculating coordinates, at which each subplot is placed, based on the feature value.

10. The multidimensional data visualization method according to claim 9, further comprising optimizing a layout position of each subplot based on the coordinates.

11. A computer readable information recording medium storing a multidimensional data visualization program, when executed by a processor, performs a method for:
generating, from input multidimensional data, a plurality of subplots as charts representing data on some dimensions in the multidimensional data;
calculating a feature value of a relationship between paired subplots for each pair of subplots; and
calculating coordinates, at which each subplot is placed, based on the feature value.

12. The computer readable information recording medium according to claim 11, further comprising:
optimizing a layout position of each subplot based on the coordinates.
